(19) United States
(12) Patent Application Publication
(10) Pub. No.: US 2023/0015964 A1
(43) Pub. Date: Jan. 19, 2023

(54) USE OF DATE SACCHARIDES ONLY OR IN ADMIXTURE WITH POLYPHENOLS TO PROTECT PLANTS AGAINST PATHOGENS

(71) Applicant: MYTAMAR GMBH, WALCHWIL (CH)

(72) Inventor: Fethi HAKKAR, PARIS (FR)

(73) Assignee: MYTAMAR GMBH, WALCHWIL (CH)

(21) Appl. No.: 17/781,991

(22) PCT Filed: Dec. 1, 2020
(86) PCT No.: PCT/EP2020/084058

§ 371 Date: Jun. 2, 2022

(30) Foreign Application Priority Data
Dec. 2, 2019 (CH) 01521/19

(51) Int. Cl. A01N 65/40; A01N 43/16

(52) U.S. Cl. CPC A01N 65/40; A01N 43/16; A01N 2300/00

(57) ABSTRACT

The use of an extract of water-soluble saccharides derived from the Phoenix dactylifera date fruits to protect plants against pathogens. In particular, the application of such an extract is used to stimulate the plant's defence and resistance responses during treatment or prevention, particularly to induce an eliciting activity of the defence mechanisms.

### FIELD OF THE INVENTION

The present invention belongs to the technical field of agronomic or agricultural protection products, and relates to the use of a saccharide extract, or a mixture of saccharide extracts and polyphenols, derived from the Phoenix dactylifera date fruits to protect plants against pathogens, particularly to stimulate the plants' natural defences and develop their resistance against pathogens.

Plants are prone to regular pathogen attacks, leading to severe crop damage and even total crop loss. Downy mildew of grapes, for example, is a disease caused by Plasmopara viticola, an oomycete, which causes heavy losses every year and is likely to break out all over the world. Prevention is necessary and requires regular treatments all year round. Other pathogens, such as fungi or insects, are also dreaded in agronomic and horticultural circles.

Controlling these pathogens often involves the use of products from the chemical industry to build the plant's defence and resistance responses that are needed to sustain the crop and its yield. However, whilst such treatments are effective, the impact of such products on the environment and consumer health is a source of concern. Moreover, such treatments are incompatible with organic farming.

Thus, for several years now, the use of naturally occurring substances as protective agents for plants against pathogens has been a research topic. These substances can be plant-, animal- or mineral-based. They are generally short-lived, thus reducing their presence in food products and in the environment. They can act in various ways, for example by stimulating the plant's natural defences or by acting directly on a pathogen population to inhibit its growth and development.

Examples of compounds that act by triggering the plant's defence mechanisms include laminarin extracted from brown seaweed or grape marc extract.

Although plants do not have an immune system equivalent to that of humans and animals, they are capable of building up defence mechanisms that can be induced by compounds acting as signals on the defence genes to trigger the synthesis of anti-pathogenic molecules or molecules capable of structurally strengthening the plant. Such compounds are called elicitors.

Thus, if a plant is brought into contact with an elicitor compound before it comes into contact with a pathogen, the plant will be somewhat immune to that pathogen.

Elicitors are therefore particularly useful in controlling plant pathogens.

### DISCLOSURE OF THE INVENTION

Thus, the need to come up with naturally occurring, environmentally-, crop- and health-friendly compounds for plant protection has become a prime concern. In particular, there is a need to identify and propose such compounds that demonstrate active stimulation of the plant defence system against pathogens and inhibition of pathogen growth and development.

It is in this context that the applicant company has worked and demonstrated that compounds derived from Phoenix dactylifera date fruits can protect plants against pathogens, and can particularly induce and stimulate plant defence reactions against pathogens.

Thus, the present invention relates to the use of a water-soluble saccharide extract derived from the Phoenix dactylifera date fruits to protect plants against pathogens.

In particular, according to the invention, such an extract is used to stimulate the plant's defence and resistance responses during treatment or prevention, particularly to induce an eliciting activity of the defence mechanisms.

Dates can be considered as a useful source of compounds with various biological activities. Additionally, a sizeable share of date production is processed into by-products, such as jams, juices and syrups. Consequently, a large amount of date stones and unmarketed fruit is produced as a waste product that can be exploited by virtue of its high content of bioactive compounds such as polysaccharides.

Indeed, a saccharide extract in the context of the invention may comprise an amount of saccharides greater than or equal to 40 wt %, 50 wt % or even 60 wt % of the extract.

According to a characteristic of the invention, the saccharides contain rhamnose, arabinose, fucose, xylose, mannose, galactose, galacturonic acid, glucose and/or glucuronic acid.

Within the meaning of the invention, saccharides are monosaccharides, oligosaccharides or polysaccharides. Preferably, they are polysaccharides.

Polysaccharides are naturally abundant organic compounds. They are homo- or hetero-polymers formed by the linear or branched linking of monosaccharides.

The polysaccharides found in dates are cellulose, pectin and hemicelluloses. These polysaccharides belong to the category of dietary fibres and are divided into two groups: soluble or water-soluble fibres comprising pectins and some hemicelluloses, and insoluble or water-insoluble fibres comprising cellulose and some other hemicelluloses.

The saccharides, according to a preferred embodiment of the invention, are naturally water-soluble polysaccharides or a mixture of such polysaccharides with hydrolysates of naturally non-water-soluble polysaccharides.

Indeed, the extraction carried out on date fruits allows to obtain a fraction enriched in soluble and insoluble polysaccharides. The initially insoluble polysaccharides can be exploited as part of the invention once they have been made water-soluble, particularly after implementation of an enzymatic or chemical hydrolysis method, for example by acid hydrolysis.

According to one embodiment of the invention, the saccharide extract contains:
at least 20 wt % mannose,
at least 7 wt % arabinose,
at least 6 wt % glucose,
at least 5 wt % galactose.

This saccharide extract is generally obtained from the date fruit stone.

According to one embodiment of the invention, the saccharide extract contains:
at least 40% galacturonic acid,
at least 7 wt % arabinose,
at least 3 wt % xylose.

This saccharide extract is obtained from the skin and pulp tissues of date fruits.

As will be shown in the following examples, polysaccharides extracted from dates have a very high inductive effect on the natural defences of plants. In particular, they allow the induction of the most representative genes of the PR (Pathogenesis Related) proteins involved in plant defence responses. They are therefore effective agents for stimulating the natural defence responses of plants.

PR proteins build up in the tissues of a plant in response to biotic or abiotic stress, or following the application of a defence-inducing product. Each PR protein has its own function. They build up at a local and systemic level, and their presence is an indicator that the plant is building up its defence mechanisms.

PR1 proteins are reportedly involved in sterol sequestration. They reportedly have an anti-fungal and anti-oomycete action, through the inhibition of spore growth and germination, particularly with regard to downy mildew and grey rot of tomato (Niderman et al., 1995; Gamir et al., 2016). They also reportedly have a beneficial effect on drought resistance (Liu et al., 2013).

PR2 proteins have a glucanase effect (β-3-1,3- glucanases), responsible for glucan degradation, a major polysaccharide constituent of the fungal wall (Benhamou, 2009). PR2 is induced in response to the salycilic acid pathway. PR2 is a protein that may also be involved in tolerance to abiotic stresses such as drought (Liu et al., 2013).

PR3 proteins have chitinase activity. They have a direct antimicrobial effect through the degradation of the fungal wall and an indirect effect via the possible release of defence gene inducing fragments (Benhamou, 2009).

PR4 proteins have shown ribonuclease and chitinase activity. Studies on wheat have suggested anti-fungal activity against Fusarium culmorun (Bertini et al., 2009; Caruso et al., 2001; Filipenko et al., 2013). Another study reported possible antifungal activity in maize (Bravo et al., 2003). PR4 is a protein that appears to be activated by both SA and JA pathways (Bertini et al., 2003; Wang et al., 2011).

PR5 proteins are “Thaumatin like” proteins with activity against oomycetes but also against Verticillium, Fusarium, and necrotrophic fungi. This protein also induces drought tolerance (Liu et al., 2013).

PR8 proteins exhibit antibacterial action through lysosomal and antifungal activity, by catalysing chitin hydrolysis in fungal walls and inhibiting hyphal growth. Through their degradative effect, they are reportedly responsible for producing endogenous elicitors, thus triggering defence responses within the attacked plant (Metraux et al., 1988).

PR14 proteins are lipid transfer proteins, expressed in young leaves and appear to have a role in the transportation of cutin monomers; they are associated with cutin and wax assembly (Sels et al., 2008). They have antimicrobial properties, for example against Pseudomonas, Fusarium, Pythium and Botrytis (Kido et al., 2010).

According to an embodiment of the invention, the extract further contains at least 5 wt % of proteins, preferably at least 10 wt %, more preferably between 5 and 15 wt %.

According to an advantageous embodiment of the invention, the water-soluble saccharide extract is a mixture with a polyphenol extract also derived from the Phoenix dactylifera date fruit.

The mixture will be in the form of a composition.

Polyphenols are antioxidant compounds specific to the plant kingdom, with various biological activities demonstrated by numerous studies described in the scientific literature. In particular, their antioxidant, anti-inflammatory, antimicrobial, antiviral or anticancer activity can be mentioned.

Advantageously, according to the invention, the saccharide/polyphenol ratio ranges between 30/70 and 70/30, expressed by weight.

Polyphenols are present in all plant organs. They have a very broad variety of structures. Thus, they are divided into different families:
Phenolic acids, such as hydroxy-benzoic acid derivatives and cinnamic acid derivatives;
Flavonoids such as flavan-3-ols, including catechins and tannins, and flavones, including flavonols.

The date fruit comprises three tissues: the stone, the pulp and the skin. It also undergoes four ripening stages: Hababouk, Blah (Kimri), Besser (Khalal) and Tamar. The fruit selection according to one of these stages, and according to the tissues, allows to obtain different results in terms of polyphenol content.

Advantageously, the polyphenol extract contains up to 80 wt % of polyphenols, relative to the total weight of the dry purified extract.

Preferably, the polyphenol extract contains at least 95 wt %, more preferably at least 97 wt %, even more preferably at least 99 wt % condensed tannins, relative to the total weight of polyphenols.

The condensed tannins in the extract according to the invention are oligomers or polymers of pro-anthocyanidins.

The extract can be more or less concentrated in polyphenols depending on the tissue and the stage of maturity, but also depending on the extraction method. These choices may be informed by the following examples.

According to one embodiment of the invention, an effective quantity of the saccharide extract, or of the mixture of saccharide extracts and polyphenols, supplied to the plants is at least 0.01 g per litre, preferably at least 0.1 g per litre, more preferably at least 0.7 g per litre, for a supply in liquid form, or at least 10 g per hectare, preferably at least 100 g per hectare for a supply in solid form.

The effective quantity must be sufficient to induce defence and resistance mechanisms, and varies from one plant to another or according to the treatment method. This quantity can be easily determined by a person skilled in the art.

According to one embodiment of the invention, the saccharide extract, or the mixture of saccharide extracts and polyphenols, is applied to the whole plant, to the leaves, to the flowers, to the roots, to the fruits, to the seeds, to the seedlings, to the soil, to the solid or liquid culture medium, to the culture material.

According to an embodiment of the invention, the application is performed by watering, irrigation, spraying, dipping or injection.

According to a characteristic of the invention, the plants are agronomic, ornamental, aromatic or medicinal plants, particularly, the plants are fruit plants, particularly grapevines, vegetable plants, flowers, trees, shrubs.

According to another characteristic of the invention, the plant pathogens are fungi, bacteria, viruses, nematodes, parasitic plants, protozoa or insects, in particular Plasmopara viticola.

Indeed, as will be shown in the following examples, the mixture of saccharide extracts and polyphenols has proven to be particularly effective against the pathogen responsible for downy mildew of grapes.

The invention further relates to a method for protecting a plant against pathogens, in particular for activating the plant's defence and resistance responses, the method comprising the application to said plant, or in the environment of the plant, of an effective amount of a water-soluble saccharide extract derived from the Phoenix dactylifera date fruit alone or in admixture with a polyphenol extract derived from the same date palm, the extracts being as previously described and applied in the same manner as previously mentioned.

The invention also relates to a phytosanitary product containing an effective amount of a saccharide extract from the Phoenix dactylifera date fruit alone or in admixture with a polyphenol extract from the same date palm, the extracts being as described above.

According to one embodiment, the phytosanitary product further comprises at least one other component such as a solvent, a surfactant, an emulsifier, a dispersing agent, a feedstock, a fertilising compound or a phytosanitary compound.

Advantageously, the phytosanitary product is in liquid, gel, powder or granular form.

### DETAILED DESCRIPTION OF EMBODIMENTS

The characteristics of the invention mentioned hereinabove and others will become clearer from the following description of illustrative embodiments.

Plant Material:

All date fruit varieties can be used. The fruits can be selected according to any of the following four ripening stages: Hababouk (stage 1), Blah (Kimri) (stage 2), Besser (Khalal) (stage 3), Tamar (stage 4). The tissues, i.e. skin, pulp and stone, are separated from each other. After a crushing process, the tissues are dried and ground into powder. It should be noted that at ripening stage 1, the fruit is studied entirely without separating the tissues because the stone is not yet formed.

### Example 1

Obtaining Water-Soluble Polysaccharide Extracts

Saccharide extracts can be obtained from the tissue powders according to a method whereby the first step is to extract alcohol-insoluble material (AIM), and secondly to purify the water-soluble saccharides, particularly polysaccharides, from this material. Obviously, other extraction methods can be used.

a) Obtaining Alcohol-Insoluble Material:

AIM is obtained by the following method:
Extraction step: Date powder is scattered in a previously boiled ethanol solution (96%+1% HCl) (V/P). After stirring, the mixtures are immediately cooled and placed at 4° C. overnight,
Step of filtration,
Step of rinsing with ethanol (65%+1% HCl),
Step of filtration,
Step of rinsing with acetone,
Kiln drying at 45° C.,
Obtaining a powder containing polysaccharides.

It is worth noting that, depending on the fruit's tissues and ripening stage, the percentages of alcohol-insoluble matter vary but can reach almost 90 wt % of fresh matter.

b) Method for Purification of Water-Soluble Polysaccharides from AIM:
Agitation of powders obtained in (a) in water acidified to 1% acetic acid,
Centrifugation,
Lyophilisation of the supernatant to obtain a fraction containing the soluble fibres in powder form,
The residue, i.e. the fraction containing the insoluble fibres, is put in a kiln at 45° C. for drying.

c) Determining the Weight Composition of Monosaccharides of AIMs, and the Soluble and Insoluble Polysaccharide Fractions Obtained from AIMs:

The weight composition of neutral and acidic monosaccharides is determined by gas chromatography-mass spectrometry (GC-MS). This analysis is performed on AIMs obtained from stones and on soluble fractions derived from AIMs from skin tissues, pulp and stones as well as on insoluble fractions derived from stone AIMs.

GC-MS analyses of the simple sugars composing the polysaccharide structures of the AIMs show considerable variability in quantities of polysaccharides depending on the fractions derived from pulp, skin or stones.

The results are recorded in the following table 1 wherein the units are expressed in μg/mg.

TABLE 1

| Ech | Ara | Rha | Fuc | Xyl | Man | Gal | GalA | Glc | GlcA | Total |
|---|---|---|---|---|---|---|---|---|---|---|
| MIA | 20,080 | 11,654 | 11,723 | 19,976 | 267,786 | 25,120 | 15,741 | 8,108 | 6,708 | 386,895 |
| FSN | 71,679 | 10,582 | 11,604 | 13,455 | 252,771 | 57,996 | 9,616 | 62,852 | 8,379 | 498,934 |
| FSC | 74,696 | 20,724 | 12,902 | 31,348 | 7,072 | 30,069 | 468,936 | 15,518 | 6,426 | 667,690 |
| FISN | 16,183 | 10,000 | 9,806 | 17,524 | 291,122 | 26,061 | 12,459 | 8,209 | 5,743 | 397,108 |

Rha: rhamnose; Ara: arabinose; Fuc: fucose; Xyl: xylose; Man: mannose; Gal: galactose; GalA: galacturonic acid, Glc: glucose, GlcA: glucuronic acid.
AIM: fraction of Alcohol-Insoluble Material from the stone; FSN: fraction of soluble polysaccharides obtained from stone AIMs; FSC: fraction of soluble polysaccharides obtained from pulp and skin AIMs; FISN: fraction of insoluble polysaccharides obtained from stone AIMs.

Thus, the fraction of soluble polysaccharides extracted from stones (FSN) is characterised by a polysaccharide content of approximately 50 wt %. Meanwhile, the fraction of soluble polysaccharides extracted from pulp and skin (FSC) is characterised by a polysaccharide content of more than 66 wt %.

These polysaccharides are composed of the following monosaccharides: rhamnose, arabinose, fucose, xylose, mannose, galactose, galacturonic acid, glucose and glucuronic acid.

In the fraction from the FSN stone, mannose is the most abundant monosaccharide. There is also a considerable amount of glucose. This indicates the presence of polysaccharides of the glucomannan family. In the fraction from FSC tissues and skins, galacturonic acid is present in sizeable quantities.

The presence of galactose and xylose in this fraction indicates the presence of pectin-type polysaccharides.

The fraction of insoluble polysaccharides obtained from AIMs of FISN stones is also rich in monosaccharides, particularly mannose. Mannose forms about 90% of the mass weight of the fraction of insoluble fibres. This indicates the presence of polysaccharides of the galactomannan family. Thus, it may be interesting, from this fraction of insoluble fibres, to prepare a soluble fraction of monosaccharides (see example 4) which can be used in the applications covered by the invention.

d) Determining the Protein Weight Composition of the Soluble and Insoluble Polysaccharide Fractions Obtained from Stone and Tissue (Pulp and Skin) AIMs:

The method for determining the protein concentration of the AIM, FSC, FISN and FSN fractions is based on the nitrogen and carbon determination by combustion of samples of each of these fractions, in the form of lyophilised (or freeze-dried) powder, according to the well-known Dumas method. The results are recorded in Table 2.

TABLE 2

| | Carbon % | Nitrogen % | Protein %¹ |
|---|---|---|---|
| FSN | 41.1 (+/−1.6) | 1.4 (+/−0.2) | 8.8 (+/−1.6) |
| FSC | 49.5 (+/−2.4) | 1.0 (+/−0.5) | 6.2 (+/−3.1) |
| FISN | 48.5 (+/−4.1) | 2.2 (+/− 0.4) | 13.7 (+/−2.7) |

The value in parenthesis represents the confidence interval α 0.05% with n = 3;
¹conversion using factor the 6.25 according to standard ISO16634

Depending on the samples, the contents vary from 40 to 50% for carbon and from 1.0 to 2.2% for nitrogen. These data allow to estimate protein contents ranging from 6 to 14% depending on the samples. The FISN fraction with an estimated protein content of approximately 14% is substantially richer in protein than the other fractions. There is no considerable difference between the estimated protein contents for the FSN and FSC fractions.

### Example 2

Obtaining Polyphenol Extracts:

Polyphenols can be obtained from tissue powders according to a polyphenol extraction and purification method primarily comprising the following steps:
Solid-liquid extraction with a solvent, preferably polar, and collecting an extract containing polyphenolic compounds,
Purification of the polyphenolic compounds from the extract by a solid phase chromatography method, for example in reverse phase or by ion exchange,
Collection of a purified extract concentrated in polyphenolic compounds.

The implementation process is as follows:

g of fruit tissue powder is brought into contact with 80 mL of hexane for 15 min, with stirring, and then filtered, during a first extraction. The residue obtained undergoes a second extraction by bringing it into contact with 80 mL of hexane for 15 minutes, with stirring, and then filtered. The residue obtained is collected and then nitrogen-dried for 1 hour. This step is optional.

The dry residue of the extraction is brought into contact with 30 mL of polar solvent for 15 min, with stirring, then filtered, during a first extraction. The polar solvent is composed of ethanol/water/acetic acid in a ratio of 50 to 80 ethanol: 1 to 10 acetic acid: water qsp (V/V/V) (hydroalcoholic solvent). For example, a ratio of 80:19:1 (Vol. ethanol/Vol. water/Vol. acetic acid/) is suitable. In one variant, a solvent composed of acetone/water/acetic acid in a ratio of 50 to 80 acetone: 1 to 10 of acetic acid: water qsp (V/V/V) (hydro-acetone solvent). For example, a ratio of 50:49: 1 can be used.

The extract obtained, namely E1, is kept, and the residue obtained undergoes a second extraction by bringing it into contact with 30 mL of the same solvent for 15 min. with stirring, and then filtered. The extract obtained, namely E2, is kept, and the residue obtained is collected and undergoes a third extraction by bringing it into contact with 30 mL of the same solvent for 15 min. with stirring, and then filtered. The extract obtained, namely E3, is kept. Extracts E1, E2 and E3 are mixed. A filtration is carried out to retrieve the supernatant and then the phenolic compounds in the extract are concentrated by vacuum evaporation.

The extracts were centrifuged at 4500 rpm for 10 min at 4° C. to retrieve the supernatant to be used for the Sep Pack C18 cartridge (marketed by Waters) to carry out a solid phase extraction (SPE).

SPE cartridges containing 5 g of C18 gel (Sep Pack C18 cartridge marketed by Waters) are conditioned with ethanol (20 mL) and then equilibrated with acidified water (40 mL) before the aqueous extracts of each sample (40 mL) are deposited, centrifuged initially at 4500 rpm for 10 min at 4° C. Rinsing is performed with 40 mL of acidified water (2% acetic acid), then the retained fraction is eluted with 40 mL of ethanol/water/acetic acid mixture (50 to 80 ethanol: 1 to 50 acetic acid: water qsp), preferably 50: 49:1 (V/V/V). The column is then washed with 30 mL ethanol to remove any highly hydrophobic polyphenols that may still be attached.

In a variant, the purification can be carried out using an FPX 66 ion exchange column (Rohm & Haas France SAS).

The extracts are concentrated by evaporation of the solvent and a purified fraction of polyphenols is obtained. The fraction is then dried to obtain a polyphenol powder.

The extracts obtained contain up to 80 wt % of polyphenols relative to the total weight of the dry purified extract. Additionally, the extracts contain at least 95 wt %, more preferably at least 97 wt %, even more preferably at least 99 wt % condensed tannins, relative to the total weight of polyphenols.

### Example 3

Preparing a composition containing an extract of water-soluble polysaccharides and an extract of polyphenols 70 mg of previously extracted soluble fibres are dissolved in 200 mL of water acidified with 0.1% formic acid. 70 mg of previously extracted polyphenols are dissolved in 50 mL of water acidified with 0.1% formic acid.

The two solutions are mixed, stirred and then centrifuged at 4500 rpm for 10 minutes. The supernatant is collected and dried.

The mixtures to be studied are prepared by soluble fibre-tannin fractions (50/50 w:w).

### Example 4

Obtaining and analysing a hydrolysate of initially water-insoluble polysaccharides from Phoenix dactylifera date fruits

a) Obtaining the Hydrolysate:

The objective is to prepare soluble saccharide fractions rich in oligomeric mannoses from the fraction containing insoluble polysaccharides FISN derived from AIM.

A bacterial or fungal beta-mannanase is used, particularly beta-mannanase extracted from Aspergillus niger, especially the purified beta-mannanase from Aspergillus niger marketed under the brand name Gamanase© (NOVO-NORDISK, Denmark).

The beta-mannanase unit is defined as the amount of beta-mannanase that releases an amount of reducing sugars from locust bean gum equivalent to 1 micromole of mannose per minute at pH5 and 30C.

Beta-mannanase can be immobilised by covalent bonding to the surface of a conventional carrier, or immobilised by polymerisation after being adsorbed to the surface of a conventional carrier. The liquid extract can then be hydrolysed at a temperature of 40-70° C. with the immobilised enzymes.

Identical incubation conditions were used with each β-mannanase (McCleary, B. V.,1979). The insoluble FISN fraction (20 ml, 0.5% w/v, no buffer) was incubated with β-mannanase (0.8 μkat on carob galactomannan; 0.4 μkat on soluble mannan). Aliquots (4 ml) were collected at 20 min, 1, 6 and 18 h intervals, heated to denature β-mannanase activity, freeze-dried and re-adjusted to 2 wt % carbohydrate. Aliquots (20 μl) were applied to plates prepared twice with n-PrOH-EtOH-H20 (7: 1: 2). The spots were visualised by spraying with 5% H2SO4 in EtOH and heating at 110° C. for about 10 min.

This technique solubilised 99.5% of the fraction containing insoluble fibres.
b) Analysis: determining the monosaccharide weight composition by GC-MS in the enzymatically hydrolysed insoluble fractions GC-MS analyses of polysaccharide structures of the hydrolysed and solubilised insoluble fractions show that this fraction is rich in mannose. This mannose obviously comes from polysaccharides of the galactomannan and glucomannan family since this soluble part is rich in glucose and galactose. The sugars identified are mannose (Man); galactose (Gal); a trisaccharide with a galactose/mannose ratio of 1: 2 (Gal-Man2); a tetrasaccharide with a galactose/mannose ratio of 1: 3 (Gal-Man3); and a pentasaccharide with a galactose/mannose ratio of 1: 4 (Gal-Man4). The results are recorded in Table 3 and the units in μg/mg.

TABLE 3

| | Gal- | Gal- | Gal- | | | |
|---|---|---|---|---|---|---|
| Sample | Man2 | Man3 | Man4 | Man | Gal | Glc |
| Hydrolysed | 10.3673 | 7.1482 | 9.8568 | 66.7821 | 10.0254 | 1.3697 |
| insoluble | | | | | | |
| fraction | | | | | | |

### Example 5

Demonstrating the efficacy of water-soluble polysaccharides derived from Phoenix dactylifera date fruits in stimulating natural defences of wheat.

Aim: The aim is to evaluate under semi-controlled conditions, the inducing effect of the extract containing water-soluble polysaccharides (obtained according to example 1 and thereafter named “Polysaccharides”) on the expression of 7 genes of PR proteins, markers of defence mechanisms, using the qPFD© tool (described in patent application WO2011/161388) on wheat plants.

Biological Material

The wheat plants were produced from seeds of the soft wheat variety ALIXAN. For each modality, 30 wheat grains were sown in 3 pots (2 replicates/modality) and then placed under controlled conditions for 1 week (constant 25° C., 16 h photoperiod), until the F2 emerging leaf stage. The young plants were then transferred to a climatic chamber dedicated to the experiment.

Tested and Control Products

The following modalities were compared (Table 4).

TABLE 4

| | | | Volume/ | | |
|---|---|---|---|---|---|
| | | | quantity | Number of | Period of |
| Product | Type of product | Dose | For 50 mL | applications | applications |
| Candidate | Polysaccharides | 0.7% | 350 mg | 2 | 4 days (D- |
| product | | | | | 4/DO) |
| Control | PDS* control | | | 2 | 4 days (D- |
| | | | | | 4/DO) |
| Control | Water | | | 1 | |

PDS: Recognised “Plant Defence Stimulator”

In order to facilitate the adherence of the candidate product on the wheat seedlings, Tween 20 was added to each candidate product, at a concentration of 0.05%, i.e. 25 μl per 50 ml of product.

Defence Markers Used

The 7 PR (Pathogenesis Related) protein genes below were selected as representative of the major PR proteins involved in plant defence.

PR-1: Pathogenesis-related protein 1

PR-2: Pathogenesis-related protein 2 (glucanases)

PR-4: Pathogenesis-related protein 4 (hevein-like)

PR-5: Pathogenesis-related protein 5 (thaumatin-like, osmotin)

PR-8: Pathogenesis-related protein 8 (class III chitinase)

PR-14: Pathogenesis-related protein 14 (lipid transfer protein)

PR-15: Pathogenesis-related protein 15 (oxalate oxidase)

Protocol

Two repetitions of the whole experiment were performed, as well as two analyses by quantitative PCR.

The tests were conducted in a climatic chamber, under controlled conditions (21° C. day/19° C. night, 16 h photoperiod) on wheat seedlings (⅔ leaf stage), randomised in blocks of 7 pots.

The products of each modality (2 pots) were applied twice, except for the control WATER which was applied only once (DO). The candidate product and the PDS control are applied at an interval of 4 days, on D-4 and DO. Each modality is then treated on D1 with hydrogen peroxide (H2O2) to simulate a pest attack. All treatments were carried out up to the runoff limit, using a sprayer connected to compressed air.

For each modality, ten leaf fragments (approx. 1 cm) were sampled by combining 5 F2 leaves from 5 different plants, on the following dates:
D0: initial sampling on 5 seedlings that have not received any treatment
D2: sampling 2 days after treatment
D3: sampling 3 days after treatment

These samples were placed in liquid nitrogen and then stored at −80° C. until the RNA was extracted.

RNA Extraction, Reverse Transcription and Quantitative PCR

RNAs were extracted from the collected leaf tissue using the NucleoSpin RNA Plant kit (Macherey-Nagel). The yield and quality of the extracted RNAs were evaluated using a spectrophotometer (Nanodrop ND-1000). The RNAs were then reverse transcribed into cDNA and the expression levels of 7 PR protein genes were monitored (3 technical replicates) by quantitative PCR (SYBR Green intercalating agent) using the qPFD® tool (“Quantitative Low Density Chip” developed by INRA). Relative expression levels were calculated using the 2^{-ΔΔCt} method: these are relative expressions with respect to the D0 (pre-treatment) sample at each sampling time, normalized by the geometric mean of the relative expressions of 3 reference genes (TuB, Actin, GAPDH). These relative expressions are log 2-transformed to give equal weight to gene inductions and repressions.

Results

Relative Expression Density Map of PR Protein Genes

Table 5 below presents the relative expression density map of the 7 PR protein genes. The expression levels of the 7 log 2-transformed genes are represented by a density map. This gives an overall view of the induction profile and allows direct visualization of the differences in expression levels of the marker genes between the treated samples, after subtracting the expression variations of the WATER control. Scale of variation of log 2 (relative expression): the more the value extends into the positive, the higher the induction.

TABLE 5

| | | PR PROTEINS | | | | | | |
|---|---|---|---|---|---|---|---|---|
| TREATMENTS | D | PR1 | PR2 | PR4 | PR5 | PR8 | PR14 | PR15 |
| WATER | D2 | 0.0 | 0.0 | 0.0 | 0.0 | 0.0 | 0.0 | 0.0 |
| CONTROL | D3 | 0.0 | 0.0 | 0.0 | 0.0 | 0.0 | 0.0 | 0.0 |
| PDS* | D2 | 10.1 | −0.4 | 8.7 | 7.3 | 1.9 | 0.8 | 0.5 |
| CONTROL | D3 | 6.3 | 0.1 | 5.5 | 5.8 | 0.0 | −1.4 | 0.5 |
| POLY- | D2 | 4.1 | −0.6 | 3.5 | 3.7 | 0.8 | 2.4 | −0.2 |
| SACCHARIDES | D3 | 2.1 | −0.1 | 2.9 | 3.1 | 0.3 | 0.1 | 0.4 |

The PDS control shows a very high capacity to induce the PR1, PR4 and PR5 genes, 2 and 3 days after the second treatment (D2). It also shows moderate induction of the PR8 gene at date D2. The induction profile of the PDS control in this trial is consistent with the known effects of this product. The trial is therefore validated.

The polysaccharides show a high induction of the PR1, PR4 and PR5 genes, 2 days after the second treatment (D2). The PR14 gene is also induced at a high level, 2 days after the last treatment (D2).

Fold Change of PR Protein Genes

The Fold change values of the 7 PR protein genes, for each of the treatment modalities (candidate product and PDS control), at sampling dates D2 and D3, are detailed in Tables 6 and 7 below.

The Fold change represents the ratio of expression level of a gene for a treatment modality (SDP control, candidate product) relative to the WATER control, without log 2 transformation and averaged for the 2 repeats. Fold change values greater than or equal to 2 indicate moderate to high inductions.

TABLE 6

| At D2 | | | | | | | |
|---|---|---|---|---|---|---|---|
| TREATMENTS | PR1 | PR2 | PR4 | PR5 | PR8 | PR14 | PR15 |
| WATER | 1.0 | 1.0 | 1.0 | 1.0 | 1.0 | 1.0 | 1.0 |
| CONTROL | | | | | | | |
| PDS* | 1514.6 | 0.8 | 548.8 | 253.5 | 4.1 | 3.1 | 1.4 |
| CONTROL | | | | | | | |
| POLY- | 31.3 | 0.7 | 23.1 | 39.9 | 1.8 | 6.6 | 0.9 |
| SACCHARIDES | | | | | | | |

TABLE 7

| At D3 | | | | | | | |
|---|---|---|---|---|---|---|---|
| TREATMENTS | PR1 | PR2 | PR4 | PR5 | PR8 | PR14 | PR15 |
| WATER | 1.0 | 1.0 | 1.0 | 1.0 | 1.0 | 1.0 | 1.0 |
| CONTROL | | | | | | | |
| PDS* | 100.9 | 1.1 | 105.7 | 170.4 | 1.1 | 0.5 | 1.6 |
| CONTROL | | | | | | | |
| POLY- | 18.1 | 1.0 | 78.5 | 85.3 | 1.3 | 1.1 | 1.3 |
| SACCHARIDES | | | | | | | |

Two days after treatment, the PDS control greatly induces the PR1, PR4 and PR5 genes, at a level 253 to 1515 times higher than the WATER control. The PR8 and PR14 genes were induced 4 and 3 times more than the WATER control respectively. Polysaccharides show a high capacity to induce PR1, PR4, PR5 and PR14 genes, at a level 7 to 40 times higher than the WATER control.

Three days after treatment, the PDS control shows a high capacity to induce the PR1, PR4 and PR5 genes, 100 to 170 times higher than the WATER control. Polysaccharides greatly induce PR1, PR4 and PR5 genes, 18, 78 and 85 times higher than the WATER control, respectively.

Conclusions:

Polysaccharides derived from Phoenix dactylifera date fruits have a high capacity to induce PR protein genes in wheat. They therefore have an inductive effect on the defence genes of the wheat crop and can be used as elicitors.

### Example 6

Demonstrating the efficacy of a water-soluble polysaccharide extract derived from Phoenix dactylifera date fruits in stimulating natural defences of grapevines.

Aim: The objective is to confirm on grapevine seedlings what was observed on wheat seedlings in the previous example.

Biological Material

The grapevine seedlings were produced from seeds of the Chardonnay grape variety. They were grown for 9 to 10 weeks in a greenhouse under semi-controlled conditions (19° C., 16 hours of daylight), then selected at the 4 to 6 leaf stage and transferred to a greenhouse reserved for the experiment.

Tested and Control Products

The following modalities were compared (Table 8).

TABLE 8

| | | | Volume/ | | |
|---|---|---|---|---|---|
| | | | quantity | Number of | Period of |
| Product | Type of product | Dose | For 50 mL | applications | applications |
| Candidate | Polysaccharides | 0.7% | 350 mg | 2 | 4 days (D- |
| product | | | | | 4/DO) |
| Control | PDS* control | | | 2 | 4 days (D- |
| | | | | | 4/DO) |
| Control | Water | | | 1 | |

PDS: Recognised “Plant Defence Stimulator” (COS-OGA)

In order to facilitate the adherence of the candidate products on the grapevine seedlings, Tween 20 was added to each candidate product, at a concentration of 0.05%, i.e. 25 μl per 50 ml of product.

Defence Markers Used

The 7 PR protein genes mentioned in Example 4: PR-1; PR-2; PR-4; PR-5; PR-8; PR-14; PR-15.

Protocol Two repetitions of the whole experiment were performed, as well as two analyses by quantitative PCR.

Each block of each modality was treated twice, with the exception of the WATER control, which was applied only once (D0). Candidate products were applied at 4-day intervals (D-4/JO) and the PDS control at 6-day intervals (D-6/JO). Each modality is then treated on D1 with hydrogen peroxide (H2O2) to simulate a bio-aggressor attack. All treatments were carried out on both sides of the leaves, up to the runoff limit, using a sprayer connected to compressed air.

For each modality, 8 leaf discs (6 mm diameter) were sampled by combining 4 developed leaves from 4 different plants, on the following dates:
D0: initial sampling on 5 seedlings that have not received any treatment
D2: sampling 2 days after treatment
D3: sampling 3 days after treatment

These samples were placed in liquid nitrogen and then stored at −80° C. until the RNA was extracted.

RNA Extraction, Reverse Transcription and Quantitative PCR

The process is the same as in example 4.

Results

Relative Expression Density Map of PR Protein Genes

Table 9 below presents the relative expression density map of the 7 PR protein genes.

TABLE 9

| | | PR PROTEINS | | | | | | |
|---|---|---|---|---|---|---|---|---|
| TREATMENTS | D | PR1 | PR2 | PR4 | PR5 | PR8 | PR14 | PR15 |
| WATER | D2 | 0.0 | 0.0 | 0.0 | 0.0 | 0.0 | 0.0 | 0.0 |
| CONTROL | D3 | 0.0 | 0.0 | 0.0 | 0.0 | 0.0 | 0.0 | 0.0 |
| PDS* | D2 | 5.6 | 3.6 | 4.0 | 4.8 | 3.4 | 3.3 | 0.9 |
| CONTROL | D3 | −3.0 | −3.7 | −1.4 | −1.6 | −0.5 | −1.4 | 0.6 |
| POLY- | D2 | 3.5 | 4.1 | 4.4 | 3.6 | 1.6 | 2.3 | 1.5 |
| SACCHARIDES | D3 | −0.9 | −0.4 | 0.8 | −1.2 | 0.4 | −0.2 | 0.7 |

The PDS control shows a high capacity to induce PR protein genes, with the exception of the PR14 gene, 2 days after the second treatment (D2). In contrast, it no longer shows induction of PR protein genes 3 days after the second treatment (D3). The pattern and high level of induction at D2 of the PDS control in this trial is consistent with the known effects of this product under our conditions. The trial is therefore validated.

Polysaccharides show a high capacity to induce PR protein genes 2 days after the second application (D2).

Fold Change of PR Protein Genes

The Fold change values of the 7 PR protein genes, for each of the treatment modalities (candidate products and PDS control), at sampling dates D2 and D3, are detailed in Tables 10 and 11 below.

TABLE 10

| TREATMENTS | PR1 | PR2 | PR4 | PR5 | PR8 | PR14 | PR15 |
|---|---|---|---|---|---|---|---|
| WATER | 1.0 | 1.0 | 1.0 | 1.0 | 1.0 | 1.0 | 1.0 |
| CONTROL | | | | | | | |
| PDS* | 157.6 | 13.1 | 17.4 | 27.0 | 11.5 | 10.4 | 2.0 |
| CONTROL | | | | | | | |
| POLY- | 21.8 | 49.7 | 36.1 | 28.1 | 3.0 | 5.1 | 2.7 |
| SACCHARIDES | | | | | | | |

TABLE 11

| TREATMENTS | PR1 | PR2 | PR4 | PR5 | PR8 | PR14 | PR15 |
|---|---|---|---|---|---|---|---|
| WATER | 1.0 | 1.0 | 1.0 | 1.0 | 1.0 | 1.0 | 1.0 |
| CONTROL | | | | | | | |
| PDS* | 0.3 | 0.1 | 0.6 | 0.4 | 1.0 | 0.5 | 1.5 |
| CONTROL | | | | | | | |
| POLY- | 0.6 | 0.8 | 3.4 | 0.5 | 1.3 | 1.4 | 1.7 |
| SACCHARIDES | | | | | | | |

Two days after treatment, the PDS control induces the PR2, PR3, PR4, PR5, PR8 and PR14 genes, at a level 2 to 27 times higher than the WATER control. The PR1 gene is the most induced, 158 times higher than the WATER control. Polysaccharides show a capacity to induce PR5 and PR14 genes, at a level 3 times higher than the WATER control. They highly induce the PR1, PR3, PR4 and PR8 genes, at a level 5 to 36 times higher than the WATER control. The PR2 gene is the most induced, 50 times higher than the WATER control.

Three days after treatment, the PDS control shows a low capacity to induce the PR14 gene, at a level 1.5 times higher than the WATER control. It does not induce the other PR protein genes. Polysaccharides induce the PR3 gene, at a level 3 times higher than the WATER control.

Conclusions:

Polysaccharides derived from Phoenix dactylifera date fruits have a high capacity to induce PR protein genes in grapevine. They therefore have an inductive effect on the defence genes of the wheat crop and can be used as elicitors.

### Example 7

Demonstrating the efficacy of a mixture of water-soluble polysaccharide extract polyphenol extract derived from Phoenix dactylifera date fruits in protecting plants against grapevine downy mildew Aim: The study is conducted to determine the protective efficacy of a mixture of water-soluble polysaccharides and polyphenols against downy mildew (Plasmopara viticola) in grapevines (Vitis vinifera), at three different doses, as a preventive or curative application. The trials are carried out on vine disks under controlled conditions.

Modalities: In this study, mixtures of water-soluble polyphenols and polysaccharides (50/50 weight ratio) are applied at different doses (0.01%; 0.1%; 0.7%) (g/L) as a preventive measure, i.e. 24 hours before the plant is contaminated by Plasmopara viticola, and as a curative measure, i.e. 24 hours after the plant has been contaminated.

As controls, water and Bordeaux mixture (reference product) were also applied 24 hours before or 24 hours after the plant was contaminated by Plasmopara viticola.

Table 12 illustrates the application modalities.

TABLE 12

| | | | Preparation | Product | | Tween 20 | | Number of |
|---|---|---|---|---|---|---|---|---|
| Product | Dose | Application | volume | quantity | | 0.05% | | applications |
| Water | | −24 h | 50 ml | | | | | |
| polyphenols + polysaccharides | 0.01% | −24 h | 50 ml | 5 ml of 0.1% | | 25 | μl | 1 |
| polyphenols + polysaccharides | 0.1% | −24 h | 50 ml | 0.05 | g | 25 | μl | 1 |
| polyphenols + polysaccharides | 0.7% | −24 h | 50 ml | 0.35 | g | 25 | μl | 1 |
| Water | | +24 h | 25 ml | | | | | 1 |
| polyphenols + polysaccharides | 0.01% | +24 h | 25 ml | 2.5 ml of 0.1% | | 12.5 | μl | 1 |
| polyphenols + polysaccharides | 0.1% | +24 h | 25 ml | 0.025 | g | 12.5 | μl | 1 |
| polyphenols + polysaccharides | 0.7% | +24 h | 25 ml | 0.175 | g | 12.5 | μl | 1 |
| Bordeaux mixture | 18.75 g/L | −24 h | 50 ml | 0.9375 | g | | | 1 |

Plant material: Grapevine seedlings are obtained from seeds of the Chardonnay grape variety.

Plasmopara viticola: 5 cm diameter leaves with large sporulation spots were frozen. The strain is then multiplied just before the experiment on grapevine plants, to obtain a fresh inoculum.

Cultivation: The seedlings are grown for 6 weeks under controlled conditions (25° C., 16 h photoperiod) and then selected at the 4-leaf stage and transferred to a dedicated climatic module for experimentation at the time of inoculation (21° C. day, 19° C. night, 16-hour photoperiod).

Treatment: The products are applied by spraying with a sprayer connected to compressed air to the point of runoff on both leaf surfaces. The treatments were applied as a preventive, at−24 h before inoculation, on plants, or as a curative, at +24 h on discs.

Inoculum production and inoculation: Leaves with dense sporulation are rinsed with osmotic water and the suspension is filtered. The final inoculum concentration is adjusted to a concentration of 5.104 sp/ml. Leaf discs are made with a punch at a rate of 8 discs per Petri dish. The inoculum is then applied to the underside of the discs with a fine droplet sprayer. The dishes are kept at room temperature until they are read.

Analysis method: Results are read between 6 and 9 days after inoculation using a quantitative disease severity scale ranging from 0 to 100% sporulation covering the surface of the leaf discs.

The disease severity (intensity) is calculated by averaging the scores (%) obtained per modality. The incidence (frequency) of the disease is calculated and represents the percentage of plants affected by downy mildew. Lastly, the protection percentage is calculated by the formula ((Water control score−X score/Water control score)×100) from the severity scores.

The data were analysed with XLSTAT software using an ANOVA. The statistical analysis used to differentiate the means is the Fisher's minimum significant difference (LSD) procedure. It indicates statistically material differences at a 95% confidence level. This analysis was performed on the severity scores. In case of a non-parametric test, the Kruskal-Wallis test is used. This test is a non-parametric equivalent of the one-way ANOVA. This non-parametric test is based on a comparison of the confidence intervals of the median on a Tukey box-and-whiskers plot.

Results: The incidence and severity of downy mildew on artificially inoculated leaf discs under controlled conditions and the protection percentages are shown in Table 13 below.

TABLE 13

| | Severity | Incidence | Protection |
|---|---|---|---|
| Modality | (%) | (%) | (%) |
| Water 24 hours before | 89 | 100 | |
| inoculation | | | |
| polyphenols + polysaccharides | 83 | 100 | 7 |
| 0.01% 24 hours before inoculation | | | |
| polyphenols + polysaccharides | 73 | 100 | 18 |
| 0.1% 24 hours before inoculation | | | |
| polyphenols + polysaccharides | 35 | 100 | 61 |
| 0.7% 24 hours before inoculation | | | |
| Water 24 hours after inoculation | 96 | 100 | |
| polyphenols + polysaccharides | 79 | 100 | 18 |
| 0.01% 24 hours after inoculation | | | |
| polyphenols + polysaccharides | 80 | 10 | 17 |
| 0.1% 24 hours after inoculation | | | |
| polyphenols + polysaccharides | 71 | 100 | 26 |
| 0.7% 24 hours after inoculation | | | |
| Bordeaux mixture | 10 | 53 | 88 |

According to these data, a significantly lower severity score than the corresponding treated water control is observed for the 0.1 and 0.7% doses of the polyphenols and water-soluble polysaccharides mixture, namely 73 and 35% respectively, with a positive dose effect. The protection rate obtained for the mixture according to the invention at the 0.7% dose is high (61%).

In curative application, a significantly lower severity score than the corresponding treated water control is also observed for the 0.01%, 0.1% and 0.7% doses of the mixture according to the invention, namely 79, 80 and 71% respectively, with a positive dose effect. The protection rate obtained for the mixture at the 0.7% dose is 30%.

Conclusion: It can be observed that the mixture has the capacity to not only induce natural defence responses in the plant and to protect it before it is attacked by the pathogen, but also to induce defence mechanisms during treatment when the plant is in contact with the pathogen.

The combination of an extract containing polysaccharides and an extract containing polyphenols is therefore particularly useful in protecting plants against pathogens. Indeed, once applied to the plant, such a mixture will be able to act in the long term, both in prevention, by inducing defence and protection mechanisms, particularly by an elicitor activity, as well as in treatment. It is therefore possible to formulate a crop care product with a broad activity spectrum.

1.-19. (canceled)

20. A method for protecting plants against pathogens, said method comprising the use of an extract of water-soluble compounds derived the Phoenix dactylifera date fruit, the extract containing at least 30 wt % of water-soluble saccharides.

21. The method according to claim 20, wherein the extract further contains at least 5 wt % of proteins.

22. The method according to claim 20, to stimulate the plant's defence and resistance responses during treatment or prevention.

23. The method according to claim 20, wherein the extract contains naturally water-soluble polysaccharides or a mixture of such polysaccharides with hydrolysates of naturally non-water-soluble polysaccharides.

24. The method according to claim 20, wherein the saccharides contain rhamnose, arabinose, fucose, xylose, mannose, galactose, galacturonic acid, glucose and/or glucuronic acid.

25. The method according to claim 20, wherein the extract contains:
at least 20 wt % mannose,
at least 7 wt % arabinose,
at least 6 wt % glucose,
at least 5 wt % galactose.

26. The method according to claim 20, wherein the extract contains:
at least 40% galacturonic acid,
at least 7 wt % arabinose,
at least 3 wt % xylose.

27. The method according to claim 20, wherein the water-soluble saccharide extract is a mixture with a polyphenol extract derived from the Phoenix dactylifera date fruit.

28. The method according to claim 27, wherein the ratio between the saccharide extract and the polyphenol extract ranges between 30/70 wt and 70/30 wt %.

29. The method according to claim 27, wherein the polyphenol extract comprises at least 95 wt % condensed tannins, relative to the total weight of polyphenols.

30. The method according to claim 20, wherein the effective quantity of the saccharide extract supplied to the plants is at least 0.01 g per litre for a supply in liquid form, or at least 10 g per hectare, for a supply in solid form.

31. The method according to claim 20, wherein the saccharide extract is applied to the whole plant, to the leaves, to the flowers, to the roots, to the fruits, to the seeds, to the seedlings, to the soil, to the solid or liquid culture medium, to the culture material.

32. The method according to claim 20, wherein the application is performed by watering, irrigation, spraying, dipping or injection.

33. The method according to claim 20, wherein the plants are agronomic, ornamental, aromatic or medicinal plants, fruit plants, grapevines, vegetable plants, flowers, trees, shrubs.

34. The method according to claim 20, wherein said plant pathogens are fungi, bacteria, viruses, nematodes, parasitic plants, protozoa or insects.

35. The method according to claim 27, wherein the effective quantity of the mixture of saccharide extracts and polyphenols supplied to the plants is at least 0.01 g per litre for a supply in liquid form, or at least 10 g per hectare for a supply in solid form.

36. The method according to claim 27, wherein the saccharide extract, or the mixture of saccharide extracts and polyphenols, is applied to the whole plant, to the leaves, to the flowers, to the roots, to the fruits, to the seeds, to the seedlings, to the soil, to the solid or liquid culture medium, to the culture material.

37. A phytosanitary product containing an effective amount of a saccharide extract from the Phoenix dactylifera date fruit alone or in admixture with a polyphenol extract from the same date palm, said extracts being as described in claim 20.

38. The phytosanitary product according to claim 37, further comprising at least one other component such as a solvent, a surfactant, an emulsifier, a dispersing agent, a feedstock, a fertilising compound or a phytosanitary compound.

39. The phytosanitary product according to claim 37, wherein the product is in liquid, gel, powder or granular form.
